(19) United States
(12) Patent Application Publication
(10) Pub. No.: US 2015/0378599 A1
(43) Pub. Date: Dec. 31, 2015

(54) METHOD AND ELECTRONIC DEVICE FOR DISPLAYING VIRTUAL KEYBOARD

(71) Applicant: Samsung Electronics Co., Ltd., Suwon-si (KR)

(72) Inventors: Gun-Uk Lee, Seoul (KR); Hye-Jin Kim, Suwon-si (KR); Byoung-Doo Park, Seoul (KR); Ra-Yeon Ahn, Seoul (KR); Sang-Wook Kwon, Yongin-si (KR)

(21) Appl. No.: 14/750,278

(22) Filed: Jun. 25, 2015

(30) Foreign Application Priority Data
Jun. 26, 2014 (KR) 10-2014-0079140

(51) Int. Cl. G06F 3/0488; G06F 3/041

(52) U.S. Cl. CPC G06F 3/04886; G06F 3/0416

(57) ABSTRACT

The present disclosure relates to a sensor network, Machine Type Communication (MTC), Machine-to-Machine (M2M) communication, and technology for Internet of Things (IoT). The present disclosure may be applied to intelligent services based on the above technologies, such as smart home, smart building, smart city, smart car, connected car, health care, digital education, smart retail, security and safety services. A method and an electronic device for displaying a virtual keyboard are provided. The method includes detecting a touch on a virtual keyboard, determining whether the detected touch moves from a first area within the virtual keyboard to another area, and changing and displaying, when the touch moves from the first area to the other area, the virtual keyboard according to a movement direction of the touch.

### CROSS-REFERENCE TO RELATED APPLICATION(S)

This application claims the benefit under 35 U.S.C. §119(a) of a Korean patent application filed on Jun. 26, 2014 in the Korean Intellectual Property Office and assigned Serial number 10-2014-0079140, the entire disclosure of which is hereby incorporated by reference.

### TECHNICAL FIELD

The present disclosure relates to wireless communication. More particularly, the present disclosure relates to displaying a virtual keyboard.

### BACKGROUND

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched.

Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

Recently, according to the rapid development of electronic devices, such as smart phones and tablet Personal Computers (PCs), electronic devices which can perform wireless voice calls and exchange information have become daily necessities. Although the electronic devices were initially recognized as portable devices which simply can perform wireless calls, the electronic devices have been developed into multimedia devices which perform functions, such as scheduling, games, remote controls, image photographing, Internet search, and Social Networking Service (SNS) to meet user demands according to the development of technologies of the electronic devices and the introduction of wireless Internet.

More particularly, electronic devices including touch screens which enable a simultaneous input and output are currently released, and accordingly, various user interfaces using the touch screen are provided. For example, recently released electronic devices provide virtual keyboards to receive a character input from a user. More particularly, as types of electronic devices and user demands are diversified, the types of virtual keyboards have also been diversified at present. For example, various virtual keyboards having different layouts of displayed characters or virtual keyboards having different numbers of displayed characters are provided.

As described above, various virtual keyboards are provided, but the corresponding virtual keyboards should include dozens of character keys in common. As a result, each of the character keys is displayed in a very small size. More particularly, an electronic device having a small display device displays character keys which are too small to be accurately input by the user. Accordingly, when the user inputs a character through a smart keyboard, an incorrect input may be made.

Therefore, a need exists for a method and an apparatus for selectively enlarging characters displayed on a virtual keyboard in an electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for selectively enlarging characters displayed on a virtual keyboard in an electronic device.

Another aspect of the present disclosure is to provide a method and an apparatus for determining a direction of a movement of a touch detected on a virtual keyboard in an electronic device.

Another aspect of the present disclosure is to provide a method and an apparatus for determining a character group to be displayed on a virtual keyboard according to a movement direction of a touch detected on the virtual keyboard in an electronic device.

Another aspect of the present disclosure is to provide a method and an apparatus for determining a function of a virtual keyboard according to a movement direction of a multi-touch detected on the virtual keyboard in an electronic device.

Another aspect of the present disclosure is to provide a method and an apparatus for determining the types of characters to be displayed on a virtual keyboard when a multi-touch is detected on the virtual keyboard in an electronic device.

In accordance with an aspect of the present disclosure, a method of controlling a display of a virtual keyboard by an electronic device is provided. The method includes detecting a touch on a virtual keyboard, determining whether the detected touch moves from a first area within the virtual keyboard to another area, and changing and displaying, when the touch moves from the first area to the other area, the virtual keyboard according to a movement direction of the touch.

In accordance with another aspect of the present disclosure, an electronic device configured to control a display of a virtual keyboard is provided. The electronic device includes a display configured to display a virtual keyboard, a touch sensor configured to detect a touch on the virtual keyboard, and a processor configured to determine whether the detected touch moves from a first area within the virtual keyboard to another area, and to change and display the virtual keyboard according to a movement direction of the touch when the touch moves from the first area to the other area. Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device for controlling a virtual keyboard according to an embodiment of the present disclosure;

FIG. 2 is a flowchart illustrating a process in which an electronic device controls a displayed virtual keyboard according to an embodiment of the present disclosure;

FIG. 3 is a flowchart illustrating a process in which an electronic device controls a virtual keyboard divided into a plurality of areas according to an embodiment of the present disclosure;

FIG. 4 illustrates a virtual keyboard divided into a plurality of areas in an electronic device according to an embodiment of the present disclosure;

FIG. 5 illustrates a virtual keyboard divided into a plurality of areas in an electronic device according to an embodiment of the present disclosure;

FIG. 6 illustrates a virtual keyboard provided by an electronic device according to an embodiment of the present disclosure;

FIG. 7 illustrates a division of a virtual keyboard into a plurality of areas provided by an electronic device according to an embodiment of the present disclosure;

FIG. 8 illustrates a touch detected on a virtual keyboard of an electronic device moves from a particular area to another area according to an embodiment of the present disclosure;

FIG. 9 illustrates a process in which an electronic device selectively enlarges and displays character keys included in a virtual keyboard according to a movement direction of a detected touch according to an embodiment of the present disclosure;

FIG. 10 illustrates a process in which an electronic device selectively enlarges and displays character keys included in a virtual keyboard according to a movement direction of a detected touch according to an embodiment of the present disclosure;

FIG. 11 illustrates a process in which an electronic device inputs a character by using a virtual keyboard having selectively enlarged and displayed character keys according to an embodiment of the present disclosure;

FIG. 12 illustrates a process in which a touch detected on a virtual keyboard of an electronic device moves within a particular area according to an embodiment of the present disclosure;

FIG. 13 illustrates a process in which an electronic device selectively enlarges and displays special character keys included according to a movement direction of a detected touch according to an embodiment of the present disclosure;

FIG. 14 illustrates a process in which an electronic device inputs a special character by using a virtual keyboard having selectively enlarged and displayed special character keys according to an embodiment of the present disclosure;

FIG. 15 illustrates a process of dividing a virtual keyboard into a plurality of areas and controlling the divided areas when an electronic device detects a touch on the virtual keyboard according to an embodiment of the present disclosure;

FIG. 16 illustrates a process of dividing a virtual keyboard into a plurality of areas when an electronic device detects a touch according to an embodiment of the present disclosure;

FIG. 17 illustrates a process of dividing a virtual keyboard into a plurality of areas when an electronic device detects a touch according to an embodiment of the present disclosure;

FIG. 18 illustrates a process of determining a movement direction of a touch detected on a virtual keyboard of an electronic device according to an embodiment of the present disclosure;

FIG. 19 illustrates a process in which an electronic device inputs a character by using a virtual keyboard having selectively enlarged and displayed character keys according to an embodiment of the present disclosure;

FIG. 20 illustrates a process in which a multi-touch detected on a virtual keyboard of an electronic device moves from a particular area to another area according to an embodiment of the present disclosure;

FIG. 21 illustrates a process in which an electronic device executes a particular function according to a movement direction of a detected multi-touch according to an embodiment of the present disclosure;

FIG. 22 illustrates a process in which an electronic device detects a multi-touch on a virtual keyboard in a state where a character type displayed on the virtual keyboard is a consonant type according to an embodiment of the present disclosure;

FIG. 23 illustrates a process in which an electronic device changes a displayed character type according to a detected multi-touch according to an embodiment of the present disclosure; and

FIG. 24 illustrates a process in which an electronic device inputs a character by using a changed character type according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the spirit and scope of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As used in various embodiments of the present disclosure, the expressions “include”, “may include” and other conjugates refer to the existence of a corresponding disclosed function, operation, or constituent element, and do not limit one or more additional functions, operations, or constituent elements. Further, as used in various embodiments of the present disclosure, the terms “include”, “have”, and their conjugates are intended merely to denote a certain feature, numeral, operation, element, component, or a combination thereof, and should not be construed to initially exclude the existence of or a possibility of addition of one or more other features, numerals, operations, elements, components, or combinations thereof.

Further, as used in various embodiments of the present disclosure, the expression “or” includes any or all combinations of words enumerated together. For example, the expression “A or B” may include A, may include B, or may include both A and B.

While expressions including ordinal numbers, such as “first” and “second”, as used in various embodiments of the present disclosure may modify various constituent elements, such constituent elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, a first element may be termed a second element, and likewise a second element may also be termed a first element without departing from the scope of various embodiments of the present disclosure.

It should be noted that if it is described that one component element is “coupled” or “connected” to another component element, the first component element may be directly coupled or connected to the second component, and a third component element may be “coupled” or “connected” between the first and second component elements. Conversely, when one component element is “directly coupled” or “directly connected” to another component element, it may be construed that a third component element does not exist between the first component element and the second component element.

The terms as used in various embodiments of the present disclosure are merely for the purpose of describing particular embodiments and are not intended to limit the various embodiments of the present disclosure.

Unless defined otherwise, all terms used herein, including technical terms and scientific terms, have the same meaning as commonly understood by a person of ordinary skill in the art to which various embodiments of the present disclosure pertain. Such terms as those defined in a generally used dictionary are to be interpreted to have the meanings equal to the contextual meanings in the relevant field of art, and are not to be interpreted to have ideal or excessively formal meanings unless clearly defined in various embodiments of the present disclosure.

An electronic device according to various embodiments of the present disclosure may be a device capable of displaying a virtual keyboard. For example, the electronic device may include at least one of a smart phone, a tablet personal computer (PC), a mobile phone, a video phone, an e-book reader, a desktop PC, a laptop PC, a netbook computer, a personal digital assistant (PDA), a portable multimedia player (PMP), a Moving Picture Experts Group (MPEG-1 or MPEG-2) Audio Layer III (MP3) player, a mobile medical device, a camera, a wearable device (for example, a head-mounted-device (HMD), such as electronic glasses, electronic clothes, an electronic bracelet, an electronic necklace, an electronic accessory, an electronic tattoo, a smart watch, and the like).

According to various embodiments of the present disclosure, the electronic device may be a smart home appliance capable of displaying a virtual keyboard. The smart home appliance as an example of the electronic device may include at least one of, for example, a television (TV), a Digital Video Disc (DVD) player, an audio player, a refrigerator, an air conditioner, a vacuum cleaner, an oven, a microwave oven, a washing machine, an air cleaner, a set-top box, a TV box (for example, Samsung HomeSync™, Apple TV™, or Google TV™), a game console, an electronic dictionary, an electronic key, a camcorder, and an electronic picture frame.

According to various embodiments of the present disclosure, the electronic device may include at least one of various medical appliances (for example, magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), automotive infotainment device, electronic equipment for ships (for example, ship navigation equipment and a gyrocompass), avionics, security equipment, a vehicle head unit, an industrial or home robot, an automatic teller machine (ATM) of a banking system, and a point of sales (POS) of a shop.

According to various embodiments of the present disclosure, the electronic device may include at least one of a part of furniture or a building/structure, an electronic board, an electronic signature receiving device, a projector, and various kinds of measuring instruments (for example, a water meter, an electric meter, a gas meter, and a radio wave meter). The electronic device according to various embodiments of the present disclosure may be a combination of one or more of the aforementioned various devices. Further, the electronic device according to various embodiments of the present disclosure may be a flexible device. Further, it will be apparent to those skilled in the art that the electronic device according to various embodiments of the present disclosure is not limited to the aforementioned devices.

Hereinafter, an electronic device according to various embodiments of the present disclosure will be described with reference to the accompanying drawings. The term “user” as used in various embodiments of the present disclosure may indicate a person who uses an electronic device or a device (for example, artificial intelligence electronic device) that uses an electronic device.

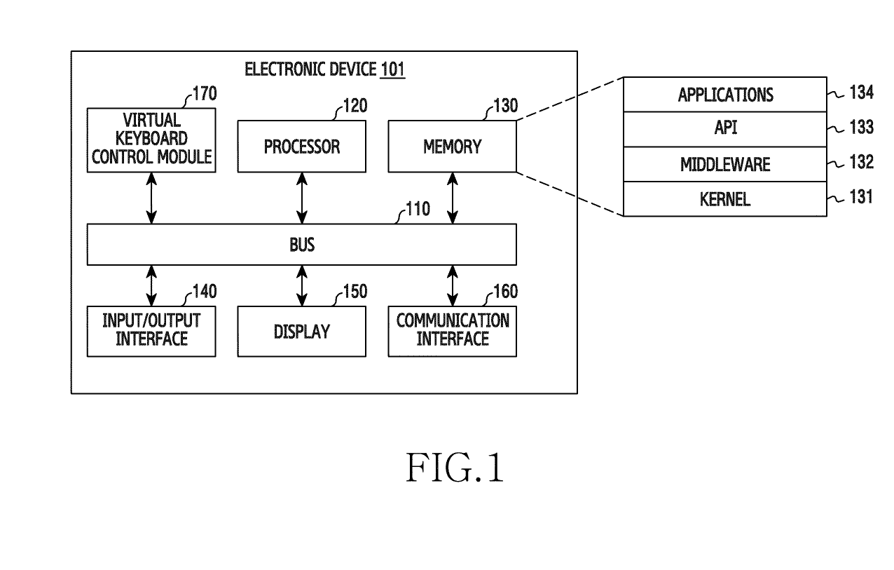

FIG. 1 is a block diagram of an electronic device for controlling a virtual keyboard according to an embodiment of the present disclosure.

Referring to FIG. 1, an electronic device 101 may include a bus 110, a processor 120, a memory 130, an input/output interface 140, a display 150, a communication interface 160, and a virtual keyboard control module 170.

The bus 110 may be a circuit that interconnects the above-described components and delivers communications (for example, a control message) between the above-described components.

The processor 120 may, for example, receive commands from other components (for example, the memory 130, the input/output interface 140, the display 150, the communication interface 160, or the virtual keyboard control module 170), through the bus 110, may decrypt the received commands, and may execute calculations or data processing based on the decrypted commands.

The memory 130 may store commands or data received from or created by the processor 120 or other components (for example, the input/output interface 140, the display 150, the communication interface 160, or the virtual keyboard control module 170). The memory 130 may include programming modules, for example, a kernel 131, middleware 132, an Application Programming Interface (API) 133, an application 134, and the like. Each of the aforementioned programming modules may be formed of software, firmware, hardware, or a combination of at least two thereof.

The kernel 131 may control or manage system resources (for example, the bus 110, the processor 120, the memory 130, and the like) used for executing an operation or function implemented in other programming modules, for example, the middleware 132, the API 133, or the applications 134. In addition, the kernel 131 may provide an interface that enables the middleware 132, the API 133, or the applications 134 to access individual components of the electronic device 101 to control or manage them.

The middleware 132 may execute as a relay so that the API 133 or the applications 134 communicates to exchange data with the kernel 131. In addition, in association with operation requests received from the applications 134, the middleware 132 may execute a control (for example, scheduling or load balancing) for the operation request, through the use of, for example, a method of assigning, to at least one of the applications 134, a priority for first using a system resource of the electronic device 101 (for example, the bus 110, the processor 120, the memory 130, and the like).

The API 133 is an interface used by the application 134 to control a function provided from the kernel 131 or the middleware 132, and may include, for example, at least one interface or function (for example, an instruction) for a file control, a window control, image processing, a character control, and the like.

According to the various embodiments of the present disclosure, the applications 134 may include a Short Message Service (SMS)/Multimedia Message Service (MMS) application, an e-mail application, a calendar application, an alarm application, a health care application (for example, an application for measuring a work rate or a blood sugar), an environment information application (for example, an application for providing atmospheric pressure, humidity, temperature information, and the like). Additionally or alternately, the applications 134 may be an application related to an information exchange between the electronic device 101 and an external electronic device. The application related to the information exchange may include, for example, a notification relay application for transferring certain information to an external electronic device or a device management application for managing an external electronic device.

For example, the notification relay application may include a function of transferring, to the external electronic device (not shown), notification information generated from other applications of the electronic device 101 (for example, an SMS/MMS application, an e-mail application, a health management application, an environmental information application, and the like). Additionally or alternatively, the notification relay application may receive notification information from, for example, an external electronic device (for example, the electronic device 104) and may provide the notification information to a user. The device management application may manage (for example, install, delete, update, and the like), for example, a function of at least a part of an external electronic device (for example, the electronic device 104) that communicates with the electronic device 101 (for example, turning on/off the external electronic device (or a few component) or adjusting brightness (or resolution) of a display), an application executed in the external electronic device, or a service provided from the external electronic device (for example, a call service or a message service).

According to various embodiments of the present disclosure, the applications 134 may include an application designated based on properties (for example, a type of electronic device) of an external electronic device (for example, the electronic device 104). For example, when the external electronic device is an MP3 player, the applications 134 may include an application related to the reproduction of music. Similarly, when the external electronic device is a mobile medical device, the applications 134 may include an application related to health care. According to an embodiment of the present disclosure, the applications 134 may include at least one of the applications designated by the electronic device 101 or applications received from an external electronic device.

The input/output interface 140 may transfer a command or data input by a user through an input/output device (for example, a sensor, a keyboard, a touch screen, and the like) to the processor 120, the memory 130, the communication interface 160, and the virtual keyboard control module 170, for example, through the bus 110. For example, the input/output interface 140 may provide the processor 120 with data associated with a touch of a user input through a touch screen. Through the input/output device (for example, a speaker or a display), the input/output interface 140 may output a command or data received, for example, through the bus 110, from the processor 120, the memory 130, the communication interface 160, and the virtual keyboard control module 170 to an input/output device (for example, a speaker or display). For example, the input/output interface 140 may output voice data processed by the processor 120 to the user through a speaker.

The display 150 may display various pieces of information (for example, multimedia data, text data, and the like) to a user.

The communication interface 160 may connect communication between the electronic device 101 and an external device. For example, the communication interface 160 may be connected to the network through wireless communication or wired communication, and may communicate with an external device. The wireless communication may include at least one of, for example, Wi-Fi, Bluetooth (BT), Near Field Communication (NFC), GPS and cellular communication (for example Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), Global System for Mobile communications (GSM, and the like). The wired communication may include at least one of, for example, a Universal Serial Bus (USB), a High Definition Multimedia Interface (HDMI), a Recommended Standard 232 (RS-232), and a Plain Old Telephone Service (POTS).

According to an embodiment of the present disclosure, the network may be a communication network. The telecommunication network may include at least one of a computer network, the Internet, the Internet of things, and a telephone network. According to an embodiment of the present disclosure, a protocol (for example, a transport layer protocol, a data link layer protocol, or a physical layer protocol) for the communication between the electronic device 101 and the external device may be supported by at least one of the applications 134, the API 133, the middleware 132, the kernel 131, and the communication interface 160.

The virtual keyboard control module 170 may process at least a part of information acquired from other components (for example, the processor 120, the memory 130, the input/output interface 140, the communication interface 160, and the like) and may provide the processed part of the information to a user in various schemes.

More particularly, the virtual keyboard control module 170 according to an embodiment of the present disclosure may detect a touch on a virtual keyboard, change the virtual keyboard based on a movement area and/or a movement direction of the corresponding touch, and display the changed virtual keyboard. More specifically, the virtual keyboard control module 170 may display the virtual keyboard according to a user's control. Thereafter, the virtual keyboard control module 170 may detect a touch on the virtual keyboard, and then detect a movement of the detected touch within the virtual keyboard. At this time, the virtual keyboard control module 170 may divide the virtual keyboard into two or more areas and identify areas within which the detected touch has moved, so as to determine the movement direction of the touch.

For example, the virtual keyboard control module 170 may pre-divide all or some areas of the virtual keyboard into two or more areas and then identify areas within which the detected touch has moved among the pre-divided two or more areas of the virtual keyboard, so as to determine the movement direction of the touch. In another example, when a touch is detected on the virtual keyboard, the virtual keyboard control module 170 may divide the area of the virtual keyboard into two or more areas based on the area where the touch is detected and identify areas within which the touch has moved among the two or more areas divided based on the area where the touch is detected, so as to determine the movement direction of the touch. At this time, the virtual keyboard control module 170 may determine movement areas of the touch and/or the movement direction of the touch based on a difference value between a coordinate value of the area where the touch is detected and a coordinate value of the area where the touch is released. Thereafter, the virtual keyboard control module 170 may identify a certain character group corresponding to the movement direction of the touch, change characters currently displayed in the area of the virtual keyboard into the identified character group, and display the changed character group. At this time, when the number of characters included in the identified character group is smaller than the number of characters displayed in the display change area of the virtual keyboard, the virtual keyboard control module 170 may enlarge the characters included in the identified character group and display the enlarged characters. The display change area of the virtual keyboard may refer to an area where changed characters are displayed according to an embodiment of the present disclosure.

According to an embodiment of the present disclosure, the display change area of the virtual keyboard may correspond to all or a part of the area of the virtual keyboard. Further, according to an embodiment of the present disclosure, the character change area of the virtual keyboard may be preset or set by a user's input. According to another embodiment of the present disclosure, the display change area of the virtual keyboard may vary depending on the number of characters included in the character group. According to another embodiment of the present disclosure, the display change area of the virtual keyboard may be configured to include the area where the touch is detected.

In addition, the virtual keyboard control module 170 may detect a multi-touch on the virtual keyboard and perform a particular function of the virtual keyboard according to movement directions of the corresponding multi-touch. The particular function of the virtual keyboard may include at least one of a word or character deletion function, a character input function, a spacing function, a commonly used sentence input function, a reserved word input function, and a recommended word input function.

Further, when a multi-touch having no mobility is detected on the virtual keyboard, the virtual keyboard control module 170 may change a currently displayed character type into another type and display the changed characters. For example, when a multi-touch is detected on the virtual keyboard in a state where vowels are displayed on the current virtual keyboard, the virtual keyboard control module 170 may change the currently displayed vowels into consonants and display the consonants. In another example, when a multi-touch is detected on the virtual keyboard in a state where consonants are displayed on the current virtual keyboard, the virtual keyboard control module 170 may change the currently displayed consonants into vowels and display the vowels. In another example, when a multi-touch is detected on the virtual keyboard in a state where Hangul (Korean alphabet) is displayed on the current virtual keyboard, the virtual keyboard control module 170 may display alphabetical characters or numbers instead of Hangul.

Referring to FIG. 1 described above, the function of the virtual keyboard control module 170 may be performed by the processor 120 according to an embodiment of the present disclosure. For example, the virtual keyboard control module 170 may be included in the processor 120.

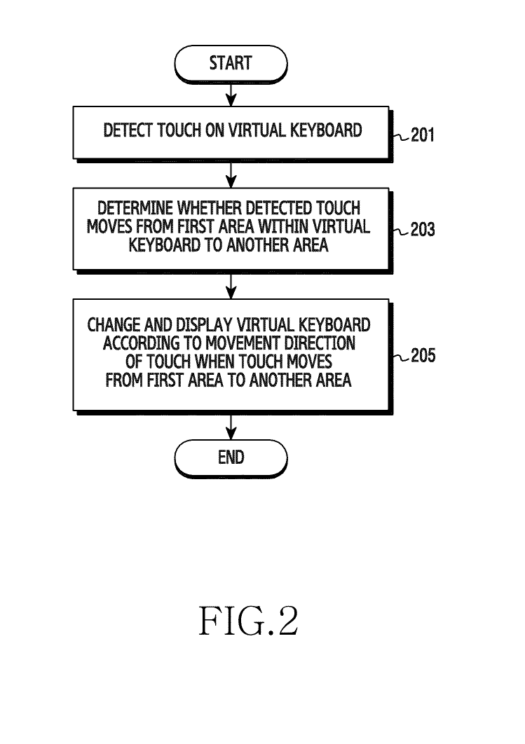

FIG. 2 is a flowchart illustrating a process in which an electronic device controls a displayed virtual keyboard according to an embodiment of the present disclosure.

Referring to FIG. 2, the electronic device may detect a touch on the virtual keyboard in operation 201. The electronic device may display the virtual keyboard.

Thereafter, the electronic device may determine whether the detected touch moves from a first area within the virtual keyboard to another area in operation 203. For example, when all or a part of the area of the virtual keyboard is pre-divided into two or more area, the electronic device may identify whether a coordinate value of the area where the touch is detected corresponds to the first area and a coordinate value of the area where the touch is released corresponds to the other area, which is not the first area, so as to determine whether the detected touch moves from the first area within the virtual keyboard to the other area. The coordinate value of the area where the touch is detected refers to a coordinate value of an area where the detection of the touch starts. In another example, when all or a part of the area of the virtual keyboard is pre-divided into two or more areas, the electronic device may determine whether the touch detected in the first area moves to another area based on a difference value between a coordinate value of the area where the touch is detected and a coordinate value of the area where the touch is released. In another example, when the area of the virtual keyboard is not pre-divided, if a touch is detected, the electronic device may divide all or a part of the area of the virtual keyboard into two or more area based on the area (first area) where the touch is detected and may determine whether the touch detected in the first area moves to another area based on a difference value between a coordinate value of the area where the touch is detected and a coordinate value of the area where the touch is released.

Thereafter, when the touch moves from the first area to the other area, the electronic device may change and display the virtual keyboard according to the movement direction of the touch in operation 205. Specifically, the electronic device may identify the movement direction of the touch, change character keys displayed on the current virtual keyboard into a character group associated with the movement direction of the touch, and display the changed characters. At this time, when the number of characters to be displayed in the display change area of the virtual keyboard after the characters are changed is smaller than the number of characters displayed before the virtual keyboard is changed, the electronic device may enlarge and display the characters included in the character group.

Thereafter, the electronic device may terminate the process according to the embodiment of the present disclosure.

In the above described embodiment of FIG. 2, after identifying that the detected touch moves from a particular area to another area, the electronic device determines a character group to be displayed based on the movement direction of the touch. According to various embodiments of the present disclosure, the electronic device may determine a character group to be displayed based on an area where the detection of the touch starts and an area where the detection of the touch ends among a plurality of divided areas of the virtual keyboard.

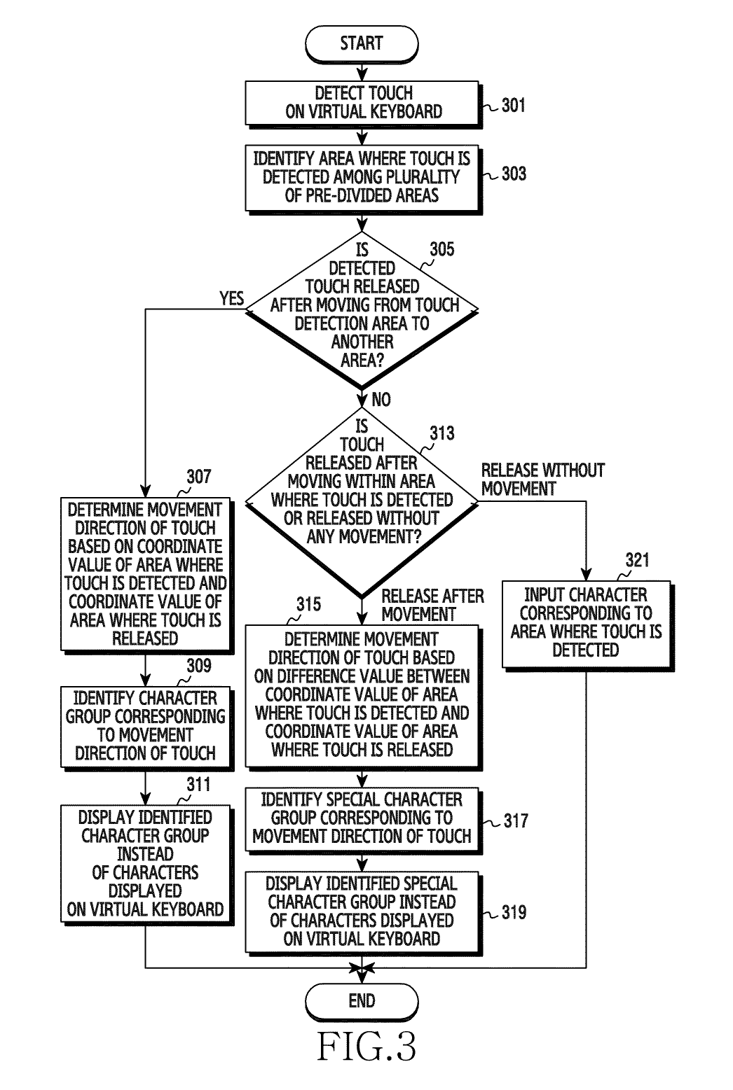

FIG. 3 is a flowchart illustrating a process in which an electronic device controls a virtual keyboard divided into a plurality of areas according to an embodiment of the present disclosure.

Referring to FIG. 3, it is assumed that all or a part of the area of the virtual keyboard is pre-divided into two or more areas.

The electronic device may detect a touch on the virtual keyboard in operation 301. The electronic device may display the virtual keyboard.

Thereafter, the electronic device may identify an area where the touch is detected among a plurality of pre-divided areas in operation 303. At this time, the virtual keyboard may be a virtual keyboard in which a character key area excluding a function key area is divided into two or more areas.

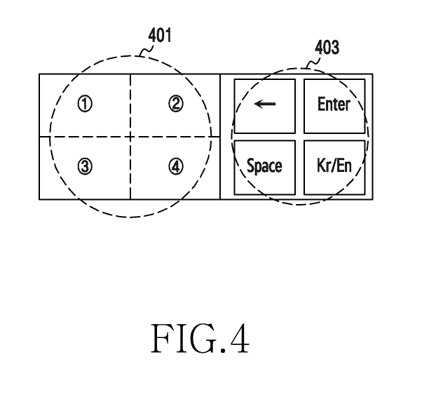

FIG. 4 illustrates a virtual keyboard divided into a plurality of areas in an electronic device according to an embodiment of the present disclosure.

Referring to FIG. 4, for example, the virtual keyboard according to an embodiment of the present disclosure may be a virtual keyboard in which a character key area 401 excluding a function key area 403 is divided into four areas as illustrated in FIG. 4. Hereinafter, for convenience of the description, a case where the character key area of the virtual keyboard excluding the function key area is divided into two or more areas will be described as an example.

Thereafter, the electronic device may identify whether the detected touch having moved from the touch detection area to another area is released in operation 305. More specifically, the electronic device may identify whether the detected touch moves to another area based on a coordinate value corresponding to a position where the touch is detected and a coordinate value corresponding to a position where the touch is released. For example, when the coordinate value corresponding to the position where the touch is detected is a coordinate value included in a first area and the coordinate value corresponding to the position where the touch is released is a coordinate value included in a second area, the electronic device may identify that the detected touch moves from the first area to the second area. In another example, when the coordinate value corresponding to the position where the touch is detected is a coordinate value included in a first area and the coordinate value corresponding to the position where the touch is released is also the coordinate value included in the first area, the electronic device may identify that the detected touch does not move from the first area to another area.

When the detected touch moves to another area and then the touch is released, the electronic device may determine the movement direction of the touch based on a coordinate value of the area where the touch is detected and a coordinate value of the area where the touch is released in operation 307.

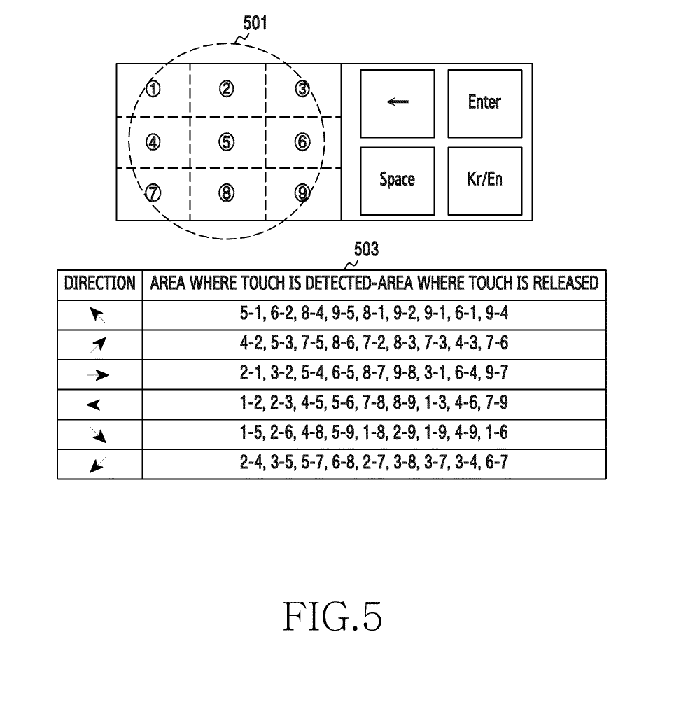

FIG. 5 illustrates a virtual keyboard divided into a plurality of areas in an electronic device according to an embodiment of the present disclosure.

Referring to FIG. 5, when the area of the virtual keyboard is divided into nine areas 501 as illustrated in FIG. 5, the electronic device may determine the movement direction of the touch based on a table 503 illustrated in FIG. 5. For example, when a coordinate value of the area where the touch is detected is a coordinate value included in a fifth area and a coordinate value corresponding to the position where the touch is released is a coordinate value included in a first area, the electronic device may determine the movement direction of the touch to be in the upper left direction. In another example, when the coordinate value of the area where the touch is detected is a coordinate value included in a fourth area and the coordinate value corresponding to the position where the touch is released is a coordinate value included in a second area, the electronic device may determine the movement direction of the touch to be in the upper right direction. In another example, when the coordinate value of the area where the touch is detected is a coordinate value included in the second area and the coordinate value corresponding to the position where the touch is released is a coordinate value included in the first area, the electronic device may determine the movement direction of the touch to be in the left direction. In another example, when the coordinate value of the area where the touch is detected is a coordinate value included in the first area and the coordinate value corresponding to the position where the touch is released is a coordinate value included in the second area, the electronic device may determine the movement direction of the touch to be in the right direction. In another example, when the coordinate value of the area where the touch is detected is a coordinate value included in the first area and the coordinate value corresponding to the position where the touch is released is a coordinate value included in the fifth area, the electronic device may determine the movement direction of the touch to be in the lower right direction. In another example, when the coordinate value of the area where the touch is detected is a coordinate value included in the second area and the coordinate value corresponding to the position where the touch is released is a coordinate value included in the fourth area, the electronic device may determine the movement direction of the touch to be in the lower left direction.

Thereafter, the electronic device may identify a character group corresponding to the movement direction of the touch in operation 309. For example, in a state where an English virtual keyboard is displayed, when the movement direction of the touch is determined to be in the upper left direction, a character group corresponding to an upper left side of the movement direction of the touch may be “Q, W, E, R, and T”. In another example, in a state where an English virtual keyboard is displayed, when the movement direction of the touch is determined to be in the upper right direction, a character group corresponding to an upper right side of the movement direction of the touch may be “Y, U, I, O, and P”. In another example, in a state where an English virtual keyboard is displayed, when the movement direction of the touch is determined to be in the left direction, a character group corresponding to a left side of the movement direction of the touch may be “A, S, D, F, and G”. In another example, in a state where an English virtual keyboard is displayed, when the movement direction of the touch is determined to be in the right direction, a character group corresponding to a right side of the movement direction of the touch may be “H, J, K, and L”. In another example, in a state where an English virtual keyboard is displayed, when the movement direction of the touch is determined to be in the lower left direction, a character group corresponding to a lower left side of the movement direction of the touch may be “Z, X, C, and V”. In another example, in a state where an English virtual keyboard is displayed, when the movement direction of the touch is determined to be in the lower right direction, a character group corresponding to a lower right side of the movement direction of the touch may be “B, N, and M”. At this time, the movement direction of the touch and the character group corresponding to the movement direction of the touch may be pre-mapped and stored, and a mapping relation therebetween is not limited to the above described examples. For example, the movement direction of the touch and the character group may be mapped in different ways from the above described way.

Thereafter, the electronic device may display the identified character group instead of the characters displayed on the virtual keyboard in operation 311. At this time, when the number of characters included in the determined character group is smaller than the number of characters displayed on the virtual keyboard, the electronic device may enlarge and display the character group, thereby preventing an incorrect input.

Thereafter, the electronic device may terminate the process according to the embodiment of the present disclosure.

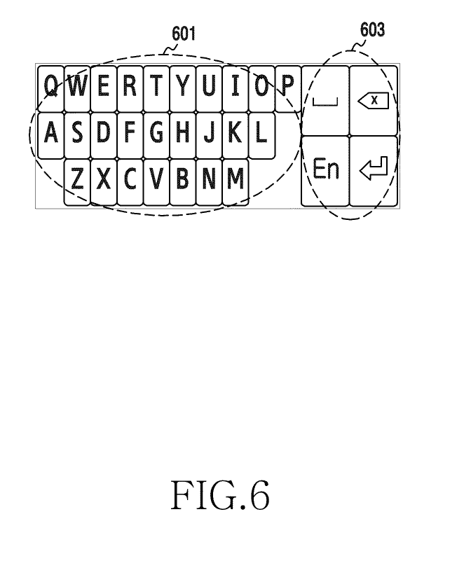

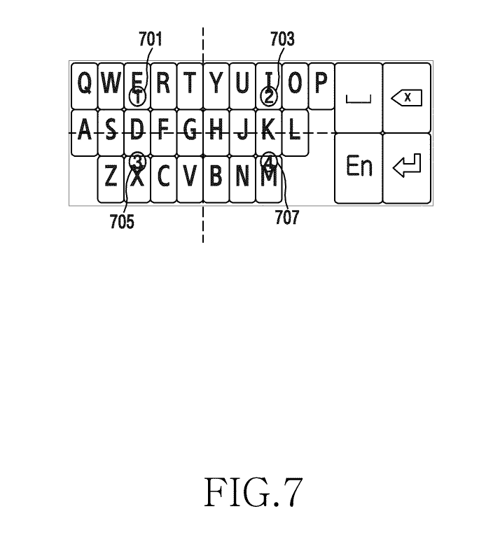

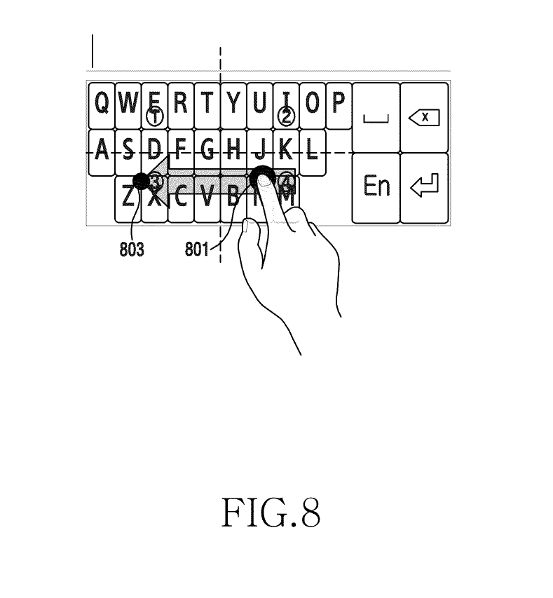

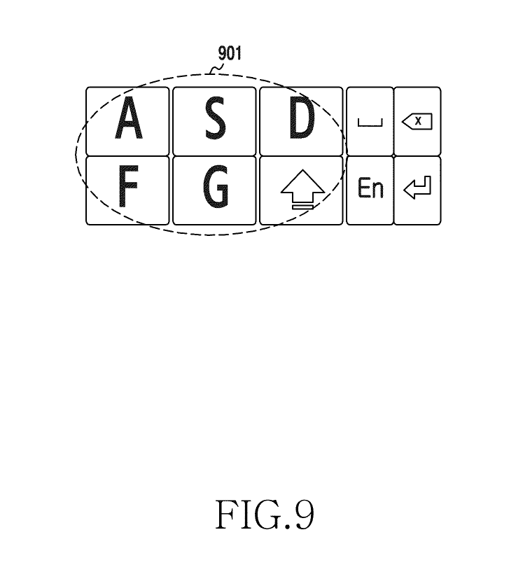

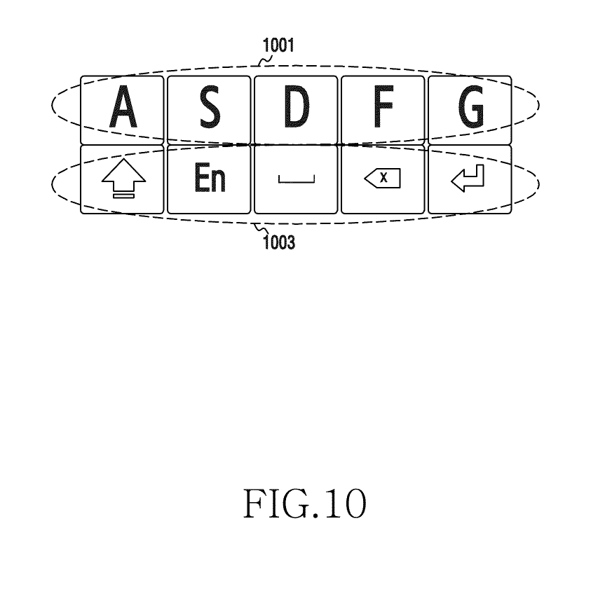

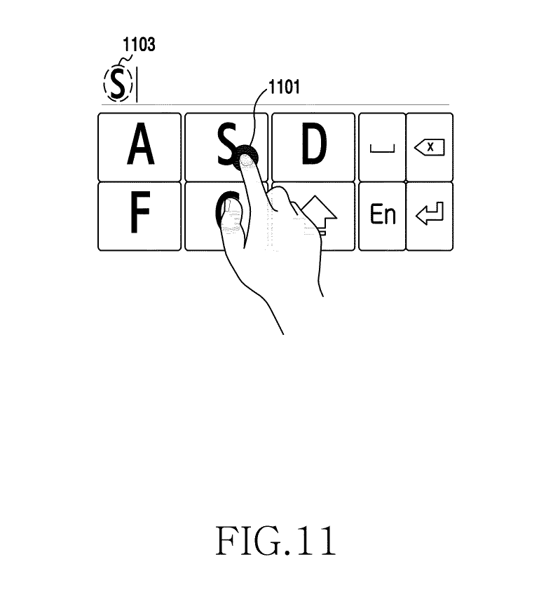

FIG. 6 illustrates a virtual keyboard provided by an electronic device according to an embodiment of the present disclosure. FIG. 7 illustrates a division of a virtual keyboard into a plurality of areas provided by an electronic device according to an embodiment of the present disclosure. FIG. 8 illustrates a touch detected on a virtual keyboard of an electronic device moves from a particular area to another area according to an embodiment of the present disclosure. FIG. 9 illustrates a process in which an electronic device selectively enlarges and displays character keys included in a virtual keyboard according to a movement direction of a detected touch according to an embodiment of the present disclosure. FIG. 10 illustrates a process in which an electronic device selectively enlarges and displays character keys included in a virtual keyboard according to a movement direction of a detected touch according to another embodiment of the present disclosure. FIG. 11 illustrates a process in which an electronic device inputs a character by using a virtual keyboard having selectively enlarged and displayed character keys according to an embodiment of the present disclosure.

Referring to FIGS. 6, 7, 8, 9, 10, and 11, the electronic device according to an embodiment of the present disclosure may display a virtual keyboard including an area 601 for displaying character keys and an area 603 for displaying particular function keys. The area 601 and the area 603 are separate from each other as illustrated in FIG. 6 for convenience of the description. At this time, referring to FIG. 7, the virtual keyboard may be a virtual keyboard having the area for displaying the character keys, which is divided into four areas 701, 703, 705, and 707. When a touch is detected on the virtual keyboard and then moves in a particular direction as illustrated in FIG. 8, the electronic device may determine the movement direction of the touch to be in the left direction based on a coordinate value 801 corresponding to a position where the touch is detected and a coordinate value 803 corresponding to a position where the touch is released. Thereafter, the electronic device may identify that the character group corresponding to the left side of the movement direction of the touch is “A, S, D, F, and G”, and may enlarge and display the identified character group “A, S, D, F, and G” in a character key area 901 of the virtual keyboard as illustrated in FIG. 9. At this time, a position to display the character group determined according to the movement direction of the touch may be variously configured.

For example, referring to FIG. 10, the electronic device may divide the area of the virtual keyboard into an upper area 1001 and a lower area 1003, display an identified character group in the upper area 1001, and display particular function keys in the lower area 1003. This is to improve user's convenience by displaying the identified character group 1001 based on the same arrangement as that of the keys of the physical keyboard. Thereafter, when a touch 1101 by the user is detected on the virtual keyboard as illustrated in FIG. 11, the electronic device may input a character “S” 1103 corresponding to a corresponding position.

Referring back to FIG. 3, when the detected touch moves to another area and is not released in operation 305, the electronic device may identify whether the touch moves within the area where the touch is detected and then is released or the touch is released without any movement in operation 313.

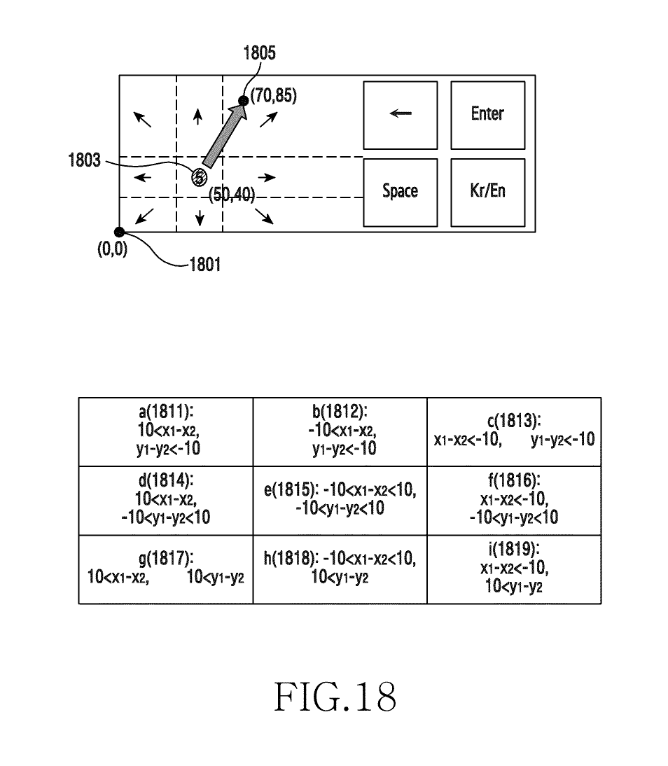

When the detected touch moves to another area and then is released, the electronic device may determine the movement direction of the touch based on a difference value between a coordinate value of the area where the touch is detected and a coordinate value of the area where the touch is released in operation 315. In other words, when the detected touch does not move to another area but the touch moves within the area where the touch is detected and then is released, the electronic device may determine the movement direction of the touch based on the difference value between the coordinate value of the area where the touch is detected and the coordinate value of the area where the touch is released. At this time, a method of determining the movement direction of the touch based on the difference value between the coordinate values will be described below with reference to FIG. 18.

Thereafter, the electronic device may identify a special character group corresponding to the movement direction of the touch in operation 317. For example, when the movement direction of the touch detected within a first area of the virtual keyboard is determined to be in the left direction, a special character group corresponding to the left side of the movement direction of the touch may be “?, !, /, :,), and @”. At this time, the movement direction of the touch and the special character group corresponding to the movement direction of the touch may be pre-mapped and stored, and a mapping relation therebetween is not limited to the above described examples. For example, the movement direction of the touch and the special character group may be mapped in different ways from the above described way.

Thereafter, the electronic device may display the identified special character group instead of the characters displayed on the virtual keyboard in operation 319. At this time, when the number of characters included in the determined special character group is smaller than the number of characters displayed on the virtual keyboard, the electronic device may enlarge and display the special character group, thereby preventing an incorrect input.

Thereafter, the electronic device may terminate the process according to the embodiment of the present disclosure.

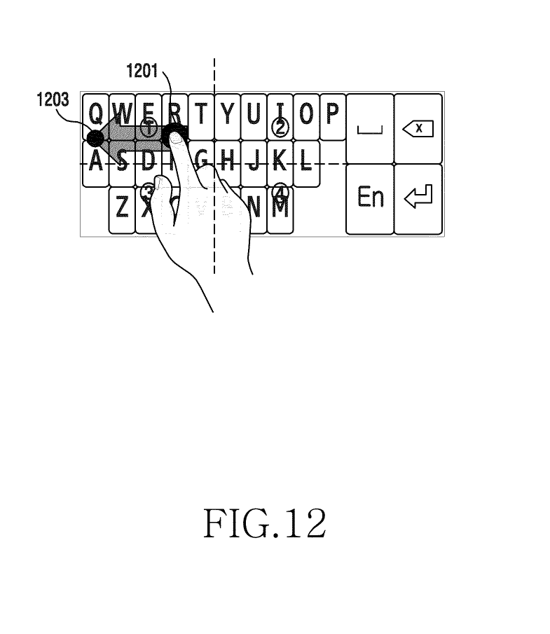

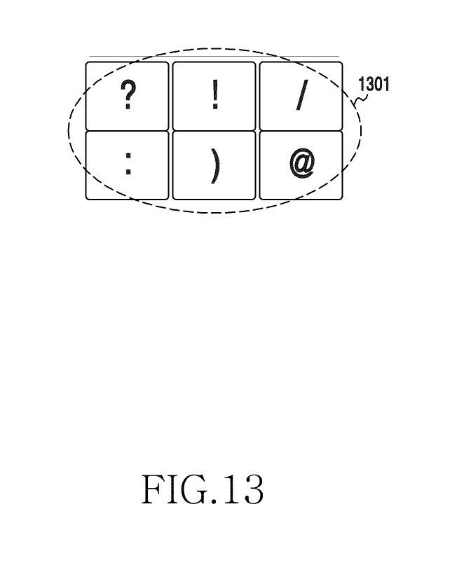

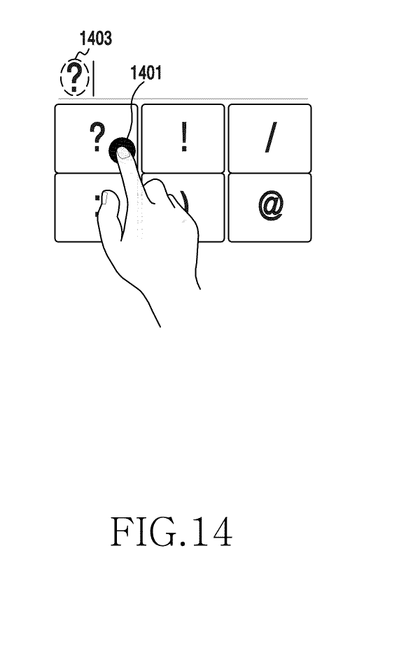

FIG. 12 illustrates a process in which a touch detected on a virtual keyboard of an electronic device moves within a particular area according to an embodiment of the present disclosure. FIG. 13 illustrates in which an electronic device selectively enlarges and displays special character keys included according to a movement direction of a detected touch according to an embodiment of the present disclosure. FIG. 14 illustrates a process in which an electronic device inputs a special character by using a virtual keyboard having selectively enlarged and displayed special character keys according to an embodiment of the present disclosure.

Referring to FIGS. 12, 13, and 14, when a touch detected in a first area of the virtual keyboard moves from the first area and then is released as illustrated in FIG. 12, the electronic device according to an embodiment of the present disclosure may determine the movement direction of the touch to be in the left direction based on a coordinate value 1201 corresponding to a position where the touch is detected and a coordinate value 1203 corresponding to a position where the touch is released. Thereafter, the electronic device may identify that a special character group corresponding to the left side of the movement direction of the touch is “?, !, /, :,), and @”, and may enlarge and display the identified special character group “?, !, /, :,), and @” in an entire area 1301 of the virtual keyboard as illustrated in FIG. 13. At this time, the special character group may be displayed in the entire area of the virtual keyboard or the character key area of the virtual keyboard according to a setting method. Thereafter, when a touch 1401 by the user is detected on the virtual keyboard as illustrated in FIG. 14, the electronic device may input a special character “?” 1403 corresponding to a corresponding position.

When the touch is released without any movement in operation 313, the electronic device may input a character corresponding to an area where the touch is detected in operation 321. In other words, when the touch is released immediately after the touch for inputting a character is detected within the virtual keyboard, the electronic device may input the character corresponding to the area where the touch is detected.

Thereafter, the electronic device may terminate the process according to the embodiment of the present disclosure.

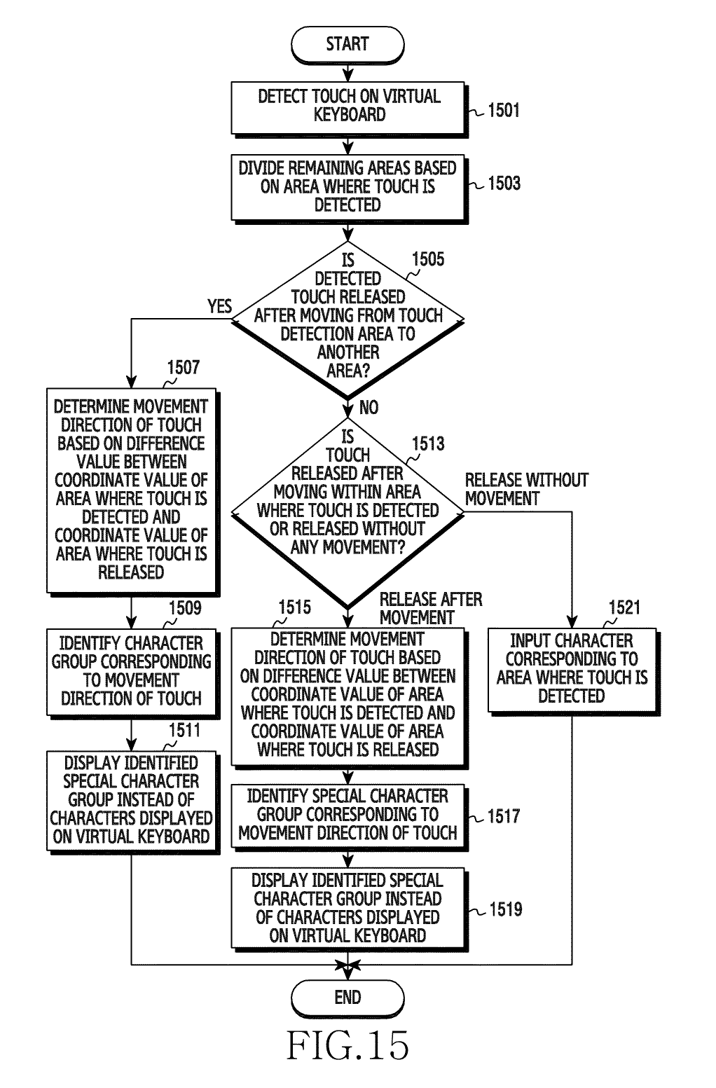

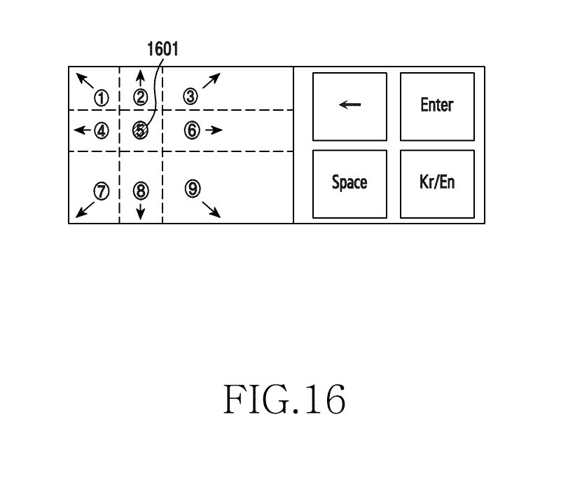

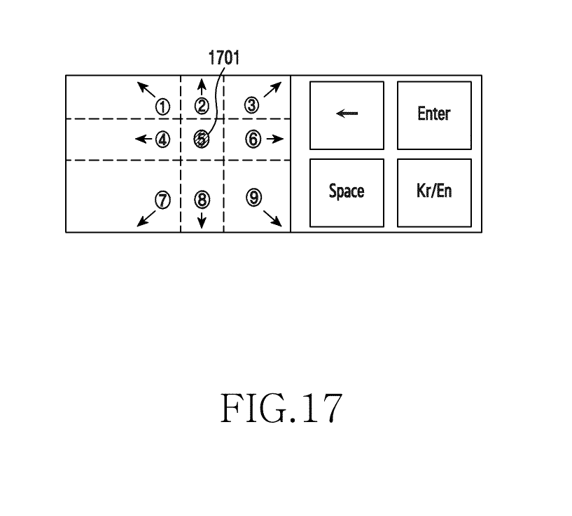

FIG. 15 illustrates a process of dividing a virtual keyboard into a plurality of areas and controlling the divided areas when an electronic device detects a touch on the virtual keyboard according to an embodiment of the present disclosure. FIG. 16 illustrates a process of dividing a virtual keyboard into a plurality of areas when an electronic device detects a touch according to an embodiment of the present disclosure. FIG. 17 illustrates a process of dividing a virtual keyboard into a plurality of areas when an electronic device detects a touch according to an embodiment of the present disclosure.

Referring to FIG. 15, all or a part of the area of the virtual keyboard is not pre-divided, and it is assumed that all or a part of the area of the virtual keyboard is divided into two or more areas when a touch is detected on the virtual keyboard.

Referring to FIGS. 15, 16, and 17, the electronic device may detect a touch on the virtual keyboard in operation 1501.

Thereafter, the electronic device may divide the remaining areas based on the area where the touch is detected in operation 1503. More specifically, the electronic device may set, as the area where the touch is detected, a certain size area based on a coordinate corresponding to the position where the touch is detected, and may divide the remaining areas around the set area. For example, when the electronic device detects a touch, the electronic device may divide the area of the virtual keyboard into nine areas based on an area corresponding to a coordinate 1601 where the touch is detected as illustrated in FIG. 16. In another example, when the electronic device detects a touch, the electronic device may divide the area of the virtual keyboard into nine areas based on an area corresponding to a coordinate 1701 where the touch is detected as illustrated in FIG. 17. At this time, the area of the virtual keyboard may be divided into areas having different sizes according to the position of the coordinate where the touch is detected.

Thereafter, the electronic device may identify whether the detected touch moves from the touch detection area to another area and then is released in operation 1505. When the detected touch moves to another area and then is released, the electronic device may determine the movement direction of the touch based on a coordinate value of the area where the touch is detected and a coordinate value of the area where the touch is released in operation 1507.

FIG. 18 illustrates a process of determining a movement direction of a touch detected on a virtual keyboard of an electronic device according to an embodiment of the present disclosure.

Referring to FIG. 18, when a coordinate value 1801 of a lower left vertex is (0, 0), a coordinate value 1803 corresponding to a position where the touch is detected is (50, 40), and a coordinate value 1805 corresponding to a position where the touch is released is (70, 85), the electronic device according to an embodiment of the present disclosure may set, as the area where the touch is detected, a certain size area based on the coordinate value 1803 of (50, 40) corresponding to the position where the touch is detected, determine whether the detected touch moves to another area based on a difference value between the coordinate value 1803 of (50, 40) corresponding to the position where the touch is detected and the coordinate value 1805 of (70, 85) corresponding to the position where the touch is released, and determine the movement direction of the touch.

At this time, it is assumed that the area where the touch is detected is an area of 20×20 based on the coordinate value corresponding to the position where the touch is detected. For example, the electronic device may determine an area to which the detected touch moves and/or a movement direction of the detected touch by determining which condition among condition a 1811 to condition i 1819 is met by the difference value between the coordinate value 1803 of (50, 40) corresponding to the position where the touch is detected and the coordinate value 1805 of (70, 85) corresponding to the position where the touch is released. In other words, when the coordinate value corresponding to the position where the touch is detected is (x1, y1) and the coordinate value corresponding to the position where the touch is released is (x2, y2), the electronic device may determine the area to which the detected touch moves and/or the movement direction of the detected touch by determining which condition among condition a 1811 to condition i 1819 is met by the two coordinate values. Here, since the difference value between the coordinate value 1803 of (50,40) corresponding to the position of the detected touch and the coordinate value 1805 of (70, 85) corresponding to the position of the released touch meets condition c 1813, the movement direction of the detected touch may be determined as an upper right direction.

According to another embodiment of the present disclosure, when the coordinate value (x1, y1) corresponding to the position of the detected touch and the coordinate value (x2, y2) corresponding to the position of the released touch meet condition a 1811, the area to which the detected touch moves may be determined as the upper left area and the movement direction of the detected touch may be determined to be in the upper left direction.

According to another embodiment of the present disclosure, when the coordinate value (x1, y1) corresponding to the position of the detected touch and the coordinate value (x2, y2) corresponding to the position of the released touch meet condition b 1812, the area to which the detected touch moves may be determined as the upper area and the movement direction of the detected touch may be determined to be in the upward direction.

According to another embodiment of the present disclosure, when the coordinate value (x1, y1) corresponding to the position of the detected touch and the coordinate value (x2, y2) corresponding to the position of the released touch meet condition c 1813, the area to which the detected touch moves may be determined as the upper right area and the movement direction of the detected touch may be determined to be in the upper right direction.

According to another embodiment of the present disclosure, when the coordinate value (x1, y1) corresponding to the position of the detected touch and the coordinate value (x2, y2) corresponding to the position of the released touch meet condition d 1814, the area to which the detected touch moves may be determined as the left area and the movement direction of the detected touch may be determined to be in the left direction.

According to another embodiment of the present disclosure, when the coordinate value (x1, y1) corresponding to the position of the detected touch and the coordinate value (x2, y2) corresponding to the position of the released touch meet condition e 1815, it may be determined that the detected touch moves within an area where the detection of the touch starts.

According to another embodiment of the present disclosure, when the coordinate value (x1, y1) corresponding to the position of the detected touch and the coordinate value (x2, y2) corresponding to the position of the released touch meet condition f 1816, the area to which the detected touch moves may be determined as the right area and the movement direction of the detected touch may be determined to be in the right direction.

According to another embodiment of the present disclosure, when the coordinate value (x1, y1) corresponding to the position of the detected touch and the coordinate value (x2, y2) corresponding to the position of the released touch meet condition g 1817, the area to which the detected touch moves may be determined as the lower left area and the movement direction of the detected touch may be determined to be in the lower left direction.

According to another embodiment of the present disclosure, when the coordinate value (x1, y1) corresponding to the position of the detected touch and the coordinate value (x2, y2) corresponding to the position of the released touch meet condition h 1818, the area to which the detected touch moves may be determined as the lower area and the movement direction of the detected touch may be determined to be in the downward direction.

According to another embodiment of the present disclosure, when the coordinate value (x1, y1) corresponding to the position of the detected touch and the coordinate value (x2, y2) corresponding to the position of the released touch meet condition i 1819, the area to which the detected touch moves may be determined as the lower right area and the movement direction of the detected touch may be determined to be in the lower right direction. Although a constant 10 is used as an example of a condition for determining the movement direction of the touch in FIG. 18 according to an embodiment of the present disclosure, another value other than the constant 10 may be used. For example, a constant value included in each condition may be set based on a size value of the area (for example, a fifth area) where the touch is detected. For example, since each of the width and the length of the fifth area is 20 (pixels), 10 which is half of 20 is used in the embodiment of the present disclosure.

Thereafter, the electronic device may identify a character group corresponding to the movement direction of the touch in operation 1509. For example, in a state where an English virtual keyboard is displayed, when the movement direction of the touch is determined to be in the upper left direction, a character group corresponding to an upper left side of the movement direction of the touch may be “Q, W, E, R, and T”. In another example, in a state where an English virtual keyboard is displayed, when the movement direction of the touch is determined to be in the upper right direction, a character group corresponding to an upper right side of the movement direction of the touch may be “Y, U, I, O, and P”. In another example, in a state where an English virtual keyboard is displayed, when the movement direction of the touch is determined to be in the left direction, a character group corresponding to a left side of the movement direction of the touch may be “A, S, D, F, and G”. In another example, in a state where an English virtual keyboard is displayed, when the movement direction of the touch is determined to be in the right direction, a character group corresponding to a right side of the movement direction of the touch may be “H, J, K, and L”. In another example, in a state where an English virtual keyboard is displayed, when the movement direction of the touch is determined to be in the lower left direction, a character group corresponding to a lower left side of the movement direction of the touch may be “Z, X, C, and V”. In another example, in a state where an English virtual keyboard is displayed, when the movement direction of the touch is determined to be in the lower right direction, a character group corresponding to a lower right side of the movement direction of the touch may be “B, N, and M”. At this time, the movement direction of the touch and the character group corresponding to the movement direction of the touch may be pre-mapped and stored, and a mapping relation therebetween is not limited to the above described examples. For example, the movement direction of the touch and the character group may be mapped in different ways from the above described way.

Thereafter, the electronic device may display the identified character group instead of the characters displayed on the virtual keyboard in operation 1511. At this time, when the number of characters included in the determined character group is smaller than the number of characters displayed on the virtual keyboard, the electronic device may enlarge and display the character group, thereby preventing an incorrect input.

Thereafter, the electronic device may terminate the process according to the embodiment of the present disclosure.

When the detected touch moves to another area and is not released in operation 1505, the electronic device may identify whether the touch moves within the area where the touch is detected and then is released or the touch is released without any movement in operation 1513.

When the detected touch moves to another area and then is released, the electronic device may determine the movement direction of the touch based on a difference value between a coordinate value of the area where the touch is detected and a coordinate value of the area where the touch is released in operation 1515. In other words, when the detected touch does not move to another area but the touch moves within the area where the touch is detected and then is released, the electronic device may determine the movement direction of the touch based on the difference value between the coordinate value of the area where the touch is detected and the coordinate value of the area where the touch is released.

Thereafter, the electronic device may identify a special character group corresponding to the movement direction of the touch in operation 1517. For example, when the movement direction of the touch detected within a first area of the virtual keyboard is determined to be in the left direction, a special character group corresponding to the left side of the movement direction of the touch may be “?, !, /, :,), and @”. At this time, the movement direction of the touch and the special character group corresponding to the movement direction of the touch may be pre-mapped and stored, and a mapping relation therebetween is not limited to the above described examples. For example, the movement direction of the touch and the special character group may be mapped in different ways from the above described way.

Thereafter, the electronic device may display the identified special character group instead of the characters displayed on the virtual keyboard in operation 1519. At this time, when the number of characters included in the determined special character group is smaller than the number of characters displayed on the virtual keyboard, the electronic device may enlarge and display the special character group, thereby preventing an incorrect input.

Thereafter, the electronic device may terminate the process according to the embodiment of the present disclosure.

When the touch is released without any movement in operation 1513, the electronic device may input a character corresponding to an area where the touch is detected in operation 1521. In other words, when the touch is released immediately after the touch for inputting a character is detected within the virtual keyboard, the electronic device may input the character corresponding to the area where the touch is detected.

Thereafter, the electronic device may terminate the process according to the embodiment of the present disclosure.

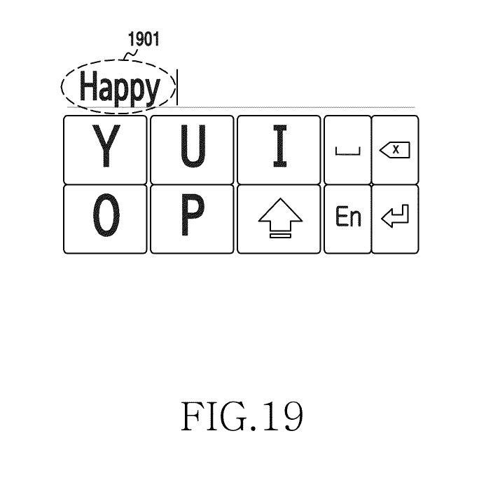

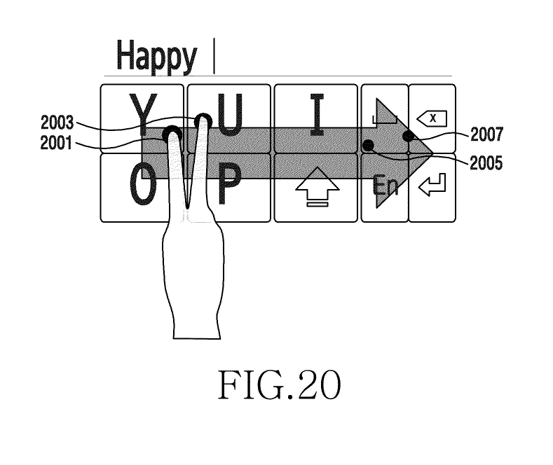

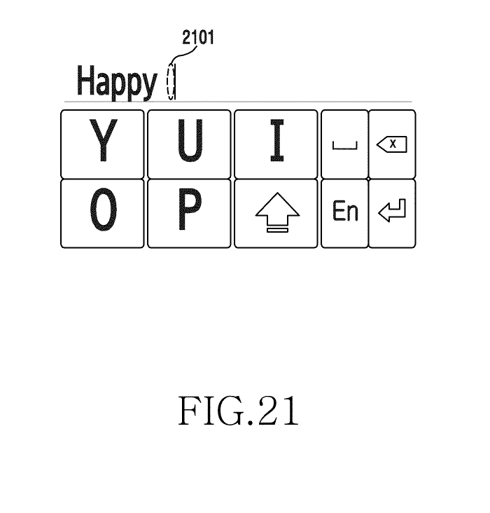

FIG. 19 illustrates a process in which an electronic device inputs a character by using a virtual keyboard having selectively enlarged and displayed character keys according to an embodiment of the present disclosure. FIG. 20 illustrates a process in which a multi-touch detected on a virtual keyboard of an electronic device moves from a particular area to another area according to an embodiment of the present disclosure. FIG. 21 illustrates a process in which an electronic device executes a particular function according to a movement direction of a detected multi-touch according to an embodiment of the present disclosure.

Referring to FIGS. 19, 20, and 21, when a multi-touch on the virtual keyboard moves in a particular direction, the electronic device according to an embodiment of the present disclosure may perform a particular function of the virtual keyboard according to the movement direction of the multi-touch. For example, when a multi-touch on the virtual keyboard is detected in a state where characters of Happy 1901 are input as illustrated in FIG. 19 and when the multi-touch moves in a right direction based coordinate values 2001 and 2003 corresponding to positions where the touches are detected and coordinate values 2005 and 2007 corresponding to positions where the touches are released as illustrated in FIG. 20, the electronic device may identify that a particular function corresponding to the right direction is a spacing function and execute the spacing function 2101. The particular function may include at least one of a word or character deletion function, a character input function, a spacing function, a commonly used sentence input function, a reserved word input function, and a recommended word input function.

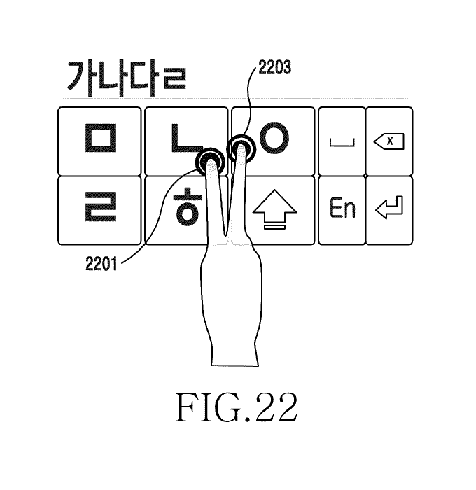

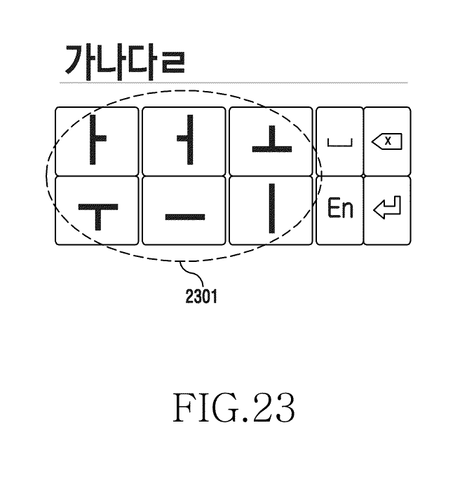

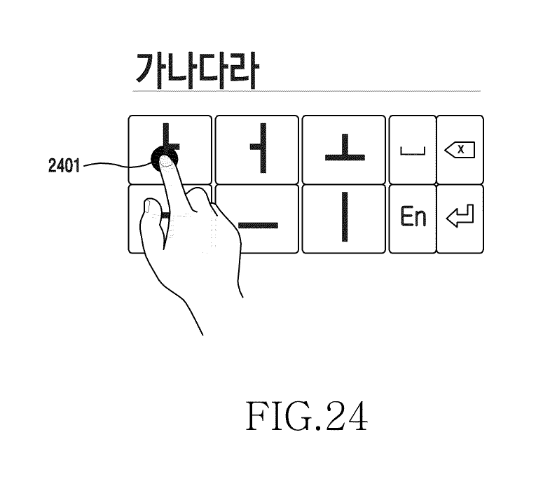

FIG. 22 illustrates a process in which an electronic device detects a multi-touch on a virtual keyboard in a state where a character type displayed on the virtual keyboard is a consonant type according to an embodiment of the present disclosure. FIG. 23 illustrates a process in which an electronic device changes a displayed character type according to a detected multi-touch according to an embodiment of the present disclosure. FIG. 24 illustrates a process in which an electronic device inputs a character by using a changed character type according to an embodiment of the present disclosure.

Referring to FIGS. 22, 23, and 24, when a multi-touch on the virtual keyboard is detected, the electronic device according to an embodiment of the present disclosure may change the type of characters currently displayed on the virtual keyboard into another type and display the changed characters. For example, when multiple touches 2201 and 2203 on the virtual keyboard are detected in a state where vowels are displayed on the current virtual keyboard as illustrated in FIG. 22, the electronic device may change the currently displayed vowels into consonants and display the consonants 2301 as illustrated in FIG. 23. Thereafter, when a touch is detected on the virtual keyboard displaying the changed consonants as illustrated in FIG. 24, the electronic device may input a character corresponding to an area 2401 where the touch is detected. The electronic device according to an embodiment of the present disclosure is not limited to the above described examples, and may change displayed vowels into consonants and display the consonants when a multi-touch is input into the virtual keyboard.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating an electronic device, the method comprising:
displaying a virtual keyboard;
detecting a touch on the virtual keyboard;
determining whether the detected touch moves from a first area within the virtual keyboard to another area; and
changing and displaying, if the touch moves from the first area to the other area, the virtual keyboard according to a movement direction of the touch.

2. The method of claim 1, wherein the changing and displaying of the virtual keyboard according to the movement direction of the touch comprises:
determining a character group corresponding to the movement direction of the touch;
determining an area of the virtual keyboard to display the character group; and
displaying the character group in the determined area of the virtual keyboard, wherein the character group includes one or more characters.

3. The method of claim 2, wherein the area to display the character group comprises one of an entire area of the virtual keyboard and a partial area of the virtual keyboard.

4. The method of claim 2, wherein the area to display the character group is determined based on at least one of an area where the touch is detected and a user setting area.

5. The method of claim 1, wherein the determining of whether the detected touch moves from the first area to the other area comprises:
determining a start coordinate and an end coordinate of the detected touch;
comparing an area corresponding to the start coordinate and an area corresponding to the end coordinate among a plurality of areas included in the virtual keyboard;
determining, if the area corresponding to the start coordinate and the area corresponding to the end coordinate are different from each other, that the detected touch moves from the first area within the virtual keyboard to the other area;
determining, if the area corresponding to the start coordinate and the area corresponding to the end coordinate are equal to each other, that the detected touch does not move from the first area to the other area.

6. The method of claim 1, wherein the determining of whether the detected touch moves from the first area to the other area comprises:
determining a start coordinate and an end coordinate of the detected touch;
dividing an area of the virtual keyboard into a plurality of areas based on the start coordinate of the touch; and
determining whether the detected touch moves from the first area of the divided areas to the other area based on the start coordinate and the end coordinate.

7. The method of claim 1, further comprising:
determining, if the touch does not move from the first area to another area, whether the touch moves within the first area; and
displaying, if the touch moves within the first area, a special character group corresponding to a movement direction of the touch on the virtual keyboard.

8. The method of claim 7, wherein the displaying of the special character group corresponding to the movement direction of the touch on the virtual keyboard comprises:
determining the special character group corresponding to the movement direction of the touch;
determining an area of the virtual keyboard to display the special character group; and
displaying the special character group in the determined area of the virtual keyboard.

9. The method of claim 1, wherein the changing and displaying of the virtual keyboard according to the movement direction of the touch comprises enlarging and displaying a character group corresponding to the movement direction of the touch on the virtual keyboard.

10. An electronic device comprising:
a display configured to display a virtual keyboard;
a touch sensor configured to detect a touch on the virtual keyboard; and
a processor configured:
to determine whether the detected touch moves from a first area within the virtual keyboard to another area, and
to change and display the virtual keyboard according to a movement direction of the touch, if the touch moves from the first area to the other area.

11. The electronic device of claim 10, wherein the processor is further configured:
to determine a character group corresponding to the movement direction of the touch,
to determine an area of the virtual keyboard to display the character group, and
to control the display to display the character group in the determined area of the virtual keyboard,
wherein the character group includes one or more characters.

12. The electronic device of claim 11, wherein the area to display the character group comprises one of an entire area of the virtual keyboard and a partial area of the virtual keyboard.

13. The electronic device of claim 11, wherein the area to display the character group is determined based on at least one of an area where the touch is detected and a user setting area.

14. The electronic device of claim 10, wherein the processor is further configured:
to determine a start coordinate and an end coordinate of the detected touch,
to compare an area corresponding to the start coordinate and an area corresponding to the end coordinate among a plurality of areas included in the virtual keyboard,
to determine that the detected touch moves from the first area within the virtual keyboard to the other area when the area corresponding to the start coordinate and the area corresponding to the end coordinate are different from each other, and
to determine that the detected touch does not move from the first area to the other area, if the area corresponding to the start coordinate and the area corresponding to the end coordinate are equal to each other.

15. The electronic device of claim 10, wherein the processor is further configured:
to determine a start coordinate and an end coordinate of the detected touch,
to divide an area of the virtual keyboard into a plurality of areas based on the start coordinate of the touch, and
to determine whether the detected touch moves from the first area of the plurality of divided areas to the other area based on the start coordinate and the end coordinate.

16. The electronic device of claim 10, wherein the processor is further configured:
to determine whether the touch moves within the first area when the touch does not move from the first area to the other area, and
to make a control to display a special character group corresponding to a movement direction of the touch on the virtual keyboard when the touch moves within the first area.

17. The electronic device of claim 16, wherein the processor is further configured:
to determine the special character group corresponding to the movement direction of the touch,
to determine an area of the virtual keyboard to display the special character group, and
to make a control to display the special character group in the determined area of the virtual keyboard.

18. The electronic device of claim 10, wherein the processor is further configured to make a control to enlarge and display a character group corresponding to the movement direction of the touch on the virtual keyboard.

19. At least one non-transitory computer readable storage medium for storing a computer program of instructions configured to be readable by at least one processor for instructing the at least one processor to execute a computer process for performing the method of claim 1.
